(19) United States
(12) Patent Application Publication
(10) Pub. No.: US 2023/0177532 A1
(43) Pub. Date: Jun. 8, 2023

(54) System and Method for Collecting Data from a User Device

(71) Applicant: Realeyes OÜ, Tallinn (EE)

(72) Inventors: Elnar HAJIYEV, Tallinn (EE); Martin SALO, Tallinn (EE); Daniel TAKACS, Tallinn (EE); Denes BOROS, Tallinn (EE); Antoine CHASSANG, Tallinn (EE)

(21) Appl. No.: 17/906,755

(22) PCT Filed: Mar. 29, 2021
(86) PCT No.: PCT/EP2021/058117

§ 371 Date: Sep. 20, 2022

(30) Foreign Application Priority Data
Mar. 31, 2020 (GB) 2004669.4

(51) Int. Cl. G06Q 30/0201; G06Q 30/0242

(52) U.S. Cl. CPC G06Q 30/0201; G06Q 30/0244

(57) ABSTRACT

A system and method for rapidly and scalably tracking user presence at a user device. The system determines if a person is at the device, i.e. in a position in which they are capable of interacting with content displayed on the device. The ability to track user presence may be linked with an ability to measure attentiveness. The system operates bymay collecting sensor data during the output of information by the user device and by mapping the sensor data to a presence parameter to obtain presence data indicative of variation of the presence parameter over time. The presence data is synchronised with contextual attribute data to generate an effectiveness data set that links evolution over time of the presence parameter with corresponding contextual attribute data obtained during the output of information.

### FIELD OF THE INVENTION

The invention relates to techniques for collecting various data, e.g. from different sources or software, while a device is outputting information or other perceptible data, where the collected data is used to assess an impact of the output information.

In one example, outputting information may comprise displaying content, and the data may be collected during the display of content. Herein the displayed content may be any information that can be consumed by a user. For example, the content can be any of: media content (e.g. video, music, images), advertising content, and webpage information.

In another example, the output information may relate to the provision of some kind of interactive content. For example, the device may be used to participate in a video-conference or the like. Alternatively, the device may be associated with an automated service provider (e.g. a robot, or other interactive machine) that is configured to engage in an interaction. The collected data may be used to assess whether or not to initiate the interaction, and/or may be used to assess the effectiveness of the interaction.

The device may be any consumer electronic device, e.g. smartphone, tablet, desktop or laptop computer, etc. The displayed content may be stored and/or generated locally, e.g. on the device. Alternatively or additionally, the device may operate within a networked environment, where the content for display is available over the network.

In particular, the invention relates to a scalable technique for detecting the presence of a person at a user device when content is displayed on the user device.

### BACKGROUND TO THE INVENTION

Certain types of media content, such as advertising, music videos, movies, etc., aim to induce changes in a consumer’s emotional state, e.g. to catch a user’s attention or otherwise engage them. In the case of advertising, it may be desirable to translate this change in emotional state into performance, such as sales lift. For example, a television commercial may look to increase sales of a product to which it relates.

The proliferation of web-enabled consumer device means that it is becoming increasingly difficult for marketers to capture consumers’ attention. For consumers to be affected by advertising messages, it is desirable that they are paying attention. The ease with which consumers can be distracted means that it is increasingly desirable to accurately track or measure parameters that are indicative of viewer attentiveness or engagement.

Many current metrics associated with delivery of content are not indicative of any interaction with a user. Such metrics may include number of impressions, number of views, view-through rate, etc. These metrics are not indicative of user attention, and in fact may not even require a human to be present.

### SUMMARY OF THE INVENTION

At its most general, the present invention proposes a system and method for rapidly and scalably tracking user presence at a user device. Herein the term “user presence” is used to mean that a person is at the device, i.e. in a position in which they are capable of interacting with content displayed on the device. The term “presence” is intended to indicate only that a person is present, and in itself does not distinguish between a present person who is paying attention to the displayed content and a present person who is distracted. However, as explained below, the ability to track user presence may be linked with an ability to measure attentiveness.

The system includes means for collecting relevant data streams from a plurality of user devices while content is displayed or during some other kind of interaction at the user device, means for analysing the collected data with an AIdriven module that may output presence data, such as one or more metrics indicative of user presence, and means for synchronising the collected data with the presence data.

The system can be implemented wholly at the user device, or may be distributed across multiple entities in a networked environment.

As mentioned above, the user device may be a consumer electronic device, such as a smartphone, tablet, laptop or desktop computer, etc. The system may be deployed within one or more apps running on the user device. For example, the functionality of the system may be provided in a software development kit (SDK) for app developers to incorporate into an app. The app may thus have an in-built capability to track user presence during operation. In another example, the functionality of the system may be provided in a stand alone module that can run in the background on the user device. Other apps may be configurable to call on the module to provide to them the functionality of the system. Alternatively or additionally, the user device may be communicable (e.g. over a network) with a remote server that is configured to provide some or all of the functionality of the system. The user device may be thus be arranged to transmit (e.g. stream) collected data to the remote server for processing. In some cases, the remote server may return result data to the user device.

The system can be configured to aggregate data to enable meaningful reports of the effectiveness of the displayed content or any other interaction at the user device to be generated. In particular, the ability to synchronise the presence metrics with other data streams can make accessible the type of events that are associated with a user’s presence, and may assist in understanding the level of exposure the content has across a cohort of users. With this information, it becomes possible to generate recommendations that enable delivery of content to be targeted in places that optimise its effectiveness. Data may be aggregated for multiple consumers (e.g. a set of users having a common demographic or interest), or over multiple pieces of content (e.g. different video ads having a common theme, or from the same advertiser), or over a certain market campaign (e.g. data from a range of different ads that are linked to a common ad campaign), or over brand (e.g. data from all content that mentions or is otherwise linked to a brand).

The system and method of the invention may find use in facilitating the optimisation of an ad campaign. The collected data allowed effective real time monitoring of the presence share of a given ad campaign, or indeed for a brand that is displayed within a number of campaigns. The system and method of the invention may provide the ability to report on the reasons driving the presence, which in turn may assist in determining what steps to take to optimise an ad delivery strategy in order to achieve a campaign objective. Campaign objectives may be set against parameters that are measurable by the system. For example, an ad campaign may have an objective to maximise total user presence time for given budget. In another example, a campaign objective may be to maximise a certain type of presence, e.g. from certain demographic group, or within a certain geographic region, or presence in the context of a certain positive emotion. In another example, a campaign objective may be to reach certain level of user presence for the lowest cost. As discussed in more detail below, the system is not only able to use the data to report on performance against a campaign objective, but also able to make prediction about how certain additional actions would affect that performance. As such, the system provides a tool for optimising an ad campaign through the provision of recommended actions that are supported by a predicted effect on performance against a campaign objective.

Additionally or alternatively, the system and method of the invention can report on the emotion state associated with the user presence, especially in circumstances where images of a user’s face are available. This may provide feedback on the whether the ad or brand is perceived positively or negatively.

According to the invention, there is provided a computer-implemented method of collecting data from a user device, the method comprising: outputting information from the user device; collecting contextual attribute data that is indicative of events occurring at the user device during the output of information; collecting, by a sensor at the user device, sensor data during the output of information; applying the sensor data to a classification algorithm to generate presence data, wherein the classification algorithm is a machine learning algorithm operable to map the sensor data to a presence parameter, and wherein the presence data is indicative of variation of the presence parameter over time during display of the content; synchronising the presence data with the contextual attribute data to generate an effectiveness data set that links evolution over time of the presence parameter with corresponding contextual attribute data obtained during the output of information; and storing the effectiveness data set in a data store.

The data from the sensor or sensors on the user device may be referred to herein as “sensor data”. The sensor data can be image data (e.g. a single captured image or a video stream) and/or audio data. In one example, the system is configured to obtain presence data from collected sensor data. As explained below, the presence data may be obtained from the sensor data in an automated manner, e.g. by applying the sensor data to one or more classification algorithms that have been trained to recognise features associated with the presence of a user. The features may be visual features, e.g. parts of a human body such as face, torso, arms, hands, legs, etc. The features may be audible features, e.g. voice. When the user device is portable, the features may be patterns of motion, e.g. associated with walking, running, etc. Data from a plurality of sensors may be used in combination to yield the presence data. Using multiple sensor types may increase the confidence in the presence data, because ambiguities in one type of sensor data can be resolved by other types of sensor data.

The output of information may relate to any kind of interaction with the user device for which it may be useful to have information about user presence. For example, the output information may be a notification of an incoming telephone or video call.

The step of outputting information may comprise displaying content on the user device. However, references to “displaying content” herein may apply equally to the output of other types of information.

In one example, the content to be displayed may comprise media content. Alternatively or additionally, the content may comprise information displayed (e.g. in a graphical user interface) during operation of a user device. The effectiveness data may thus relate to operation or use of an app or other software programme running on the user device and/or to content that is displayed through such an app or software programme.

In one example, the method may further comprise: executing an app on the user device; and playing, by the app running on the user device, the media content, wherein the contextual attribute data is further indicative of events occurring at the app during playing of the media content.

The media content may be obtained by the user device from local storage (e.g. on the user device itself) or from elsewhere, e.g. by the app over a local area or wide area network connection. In one example, the app may be or may link to a content sharing platform.

The contextual attribute data may comprise control analytics data for the app.

In one example, the system functionality may be provided by the app itself. For example, a developer of the app may incorporate a software development kit (SDK) configured to provide the functionality discussed herein. The app may thus be configured to generate the presence data and synchronise the presence data with the contextual attribute data.

In another example, the app may be configured to communicate with an analysis module running in the background on the user device. The analysis module may be configured to generate the presence data and synchronise the presence data with the contextual attribute data. The analysis module may be communicable with multiple apps. This means that the user device may have a single entity that handles presence data generation for a variety of other apps.

In a further example, the system functionality may be provided in a stand-alone app that is configured to collect data for all interactions with a given device. In other words, data is collected irrespective of the type of interaction or app currently used or the source of any content that is displayed. A user may decide to install an app of this kind to obtain information about how effectively they use the device. The effectiveness data may thus relate to the different types of use a user makes of the device. The effectiveness data may for example include a “health” report that summarises the user’s engagement and/or emotional response to their interactions with the device. As discussed below, a similar functionality may be provided by way of a browser plug-in, which can provide the system functionality for all interactions that a user has with a browser, irrespective of the identify of website publishers or source of displayed content.

The effectiveness data that is generated by the system may be displayed to the user. The effectiveness data may permit a user to track or view how they interact with an app. Such information may be of immediate local value to a user, which in turn may incentivise them to permit the effectiveness data to be shared more widely.

The app may comprise an adaptor module configured to communicate with an analysis server over a network. This may permit the effectiveness data (or indeed any data collected by the user device if suitable permission to share is obtained) from multiple user devices to be collected. The collected data may be aggregated or otherwise analysed to spot patterns, which in turn may be used to improve the content.

References to “sensor data” herein may refer to detectable information relating to the environment of the user device. The sensor data may for example comprise one or more images of a location in front of the user device. For example, the sensor may comprise a camera, e.g. a webcam, that may be built into the user device or provided separately. Where a user is present, the sensor data may include visual aspects of the user’s response. For example, the sensor data may include data indicative of any one or more of facial response, head and body gestures or pose, and gaze tracking.

The displayed content may be generated locally on the user device (e.g. by software running thereon). For example, the displayed content may be related to a game, mobile app or desktop app that runs locally. As discussed above, in one example an app running on the user device may be provided with a built-in ability to obtain presence data. That is, the app may be configured to continuously collect, using one or more sensors on the user device, sensor data from which presence data (and preferably also emotion and attention data) can be obtained. The app may run the classification algorithm locally to obtain the presence data. This data may be communicated to the analysis server to obtain the effectiveness data set mentioned above. An advantage of integrated presence data generation within an app is that the user’s interaction with the app itself can be used in either or both of the contextual attribute data and sensor data. The generated presence data may be directly displayed at the user device, e.g. through a user interface provided by the app, to show presence data in relation to app activity. Such information, preferably from a plurality of users, may be shared with a developer of the app to provide a richer understanding of how users interact with the app, e.g. to gain insight into which features of the app are strongly linked to presence, or which features are linked to a loss of presence.

Additionally or alternatively, the displayed content may be obtained from the web, e.g. by download, streaming, etc. Thus, the step of displaying the content may comprise: accessing, by the user device over a network, a webpage on a web domain hosted by a content server; receiving, by the user device over the network, the content to be displayed by the webpage. The content may be displayed directed on the webpage, or may be displayed via a media player application, either separately from or embedded in the webpage.

In this example, the method may thus operate to collect two or more of the following types of data from the user device: (i) contextual attribute data from a webpage, (ii) contextual attribute data from the media player application (if used), and (iii) sensor data. Presence data is extracted from the collected data, and all the data is synchronised to enable the causes or drivers of presence to be researched.

Accessing the webpage may include obtaining a contextual data initiation script for execution on the user device. The contextual data initiation script may be machine readable code, e.g. located in a tag within the header of the webpage.

Alternatively, the contextual data initiation script may be provided within the communication framework through with the content is supplied to the user device. For example, where the content is a video ad, the communication framework typically involves an ad request from the user device, and a video ad response sent to the user device from an ad server. The contextual data initiation script may be included in the video ad response. The video ad response may be formatted in line with a Video Ad Serving Template (VAST) specification (e.g. VAST 3.0 or VAST 4.0), or may comply with any other ad response standard, e.g. Video Player Ad Interface Definition (VPAID), Mobile Rich Media Ad Interface Definition (MRAID), etc.

In a further alternative, the contextual data initiation script may be injected into webpage source code at an intermediary between the publisher (i.e. originator of webpage) and the user (i.e. user device). The intermediary may be a proxy server, or may be a code injection component within a network router associated with the user. In these examples, the publisher need not incorporate the contextual data initiation script in its version of the webpage. This means that the contextual data initiation script need not be transmitted in response to every webpage hit. Furthermore, this technique may enable the script to be included only in requests from user devices that are associated with users that have granted permission for their behavioural data to be collected. In some examples, such users may form a panel for assessing the effectiveness of web content before it is released to a wider audience.

In a yet further alternative, the system functionality may be provided by a browser plug-in, which a user may install on the device. In this example, data may be collected for all interactions with the browser, i.e. irrespective of webpage visited. A user may benefit from this arrangement because the collected data may enable the effectiveness data for different webpages to be directly compared. A user may thus obtain information that indicates how engaged or attentive they are to different webpages.

The method may further include executing the contextual data initiation script at the user device to perform one or more preliminary operations, before the content is displayed. The preliminary operations include any of: determining consent to transmit the contextual attribute data and sensor data to a remote analysis server; determining availability of the sensor for collecting the sensor data; and ascertaining whether or not the user is selected for sensor data collection. The method may comprise terminating a sensor data collection procedure upon determining, by the user device using the contextual data initiation script that (i) consent to transmit sensor data is withheld, or (ii) the sensor for collecting the sensor data is not available, or (iii) the user is not selected for sensor data collection. A determination of any one of these criteria may cause the sensor data collection procedure to be terminated. In this case, the user device may only send the contextual attribute data to the analysis server.

The image or video data may be transmitted, e.g. streamed or other sent, from the user device using any suitable real-time communication protocol, e.g. WebRTC or the like. The method may include loading code for enabling the real-time communication protocol upon determining, by the user device using the contextual data initiation script, that (i) consent to transmit sensor data is given, and (ii) the sensor for collecting the sensor data is available, and (iii) the user is selected for sensor data collection. To avoid slowing initial access to the webpage, the code for enabling the real-time communication protocol may not be loaded until all the conditions above are determined.

In addition to the data collected from the user device, the analysis server may obtain additional information about the user from other sources. The additional information may include data indicative of demographics, user preferences, user interests, etc. The additional data may be incorporated into the effectiveness data set, e.g. as labels to permit the presence data to be filtered or sorted by demographics, user preferences or interests, etc.

The additional data may be obtained in various ways. For example, the analysis server may be in communication (directly or via the network) with an advertising system, such as a demand-side platform (DSP) for running programmatic advertising. The additional information may be obtain from a user profile held by the DSP, or can be obtained directly from the user, e.g. as feedback from a quiz, or through a social network interaction. The additional information may be obtained by analysing images captured by a webcam on the user device.

The media content may be a video, such as a video ad. The synchronisation of the presence data and contextual attribute data may be with respect to a timeline during which the video was played on the media player application. The sensor data and the contextual attribute data may be time-stamped in a manner that enables a temporal relation between the various data to be established.

Display of the media content at the webpage may be triggered by accessing the webpage, or by taking some predetermined action on the webpage. The media content may be hosted on web domain, e.g. directly embedded in the content of the webpage. Alternatively, the media content may be obtained from separate entity. For example the content server may be a publisher who provides space in the webpage for advertisers. The media content may be an ad that is transmitted (e.g. as a result of an ad bidding process) from an ad server to fill the space in the webpage. The contextual attribute data may be further indicative of events occurring at the webpage during display of the content.

The media content may be thus may outside the control of the content server. Similarly, the media player application on which the media content is played may not be software that is resident on the user device. Accordingly, the contextual attribute data relating to the webpage may need to be obtained independently from the contextual attribute data relating to the media player application.

The classification algorithm may be located at the analysis server. Having a central location may facilitate the process of updating the algorithm. However, it is also possible for the classification algorithm to be at the user device, wherein instead of transmitting the sensor data to the analysis server, the user device is arranged to transmit the presence and emotion data. An advantage of providing the classification algorithm on local devices is the increased privacy for the user, because the sensor data does not need to be transmitted away from their computer. Running the classification algorithm locally also means that the processing capability required of the analysis server is much less, which can save cost.

As mentioned above, collecting the sensor data may comprise capturing images using a camera. The contextual data initiation script may be configured to activate the camera.

The contextual attribute data may comprise web analytics data for the webpage and control analytics data for the media player application. The analytics data may include any conventionally collected and communicated information for the webpage and media player application, such as viewability of any element, clickstream data, mouse movements (e.g. scrolls, cursor location), keystrokes, etc.

Execution of the contextual data initiation script may be arranged to trigger or initialise collection of web analytics data. Analytics data from the media player application may be obtained using an adaptor module, which can be a plug-in that forms part of the media player application software, or an separate loadable software adaptor that communicates with the media player application software. The adaptor module may be configured to transmit, to the analysis server over the network, control analytics data for the media player application, and wherein the method comprises executing the adaptor module upon receiving the media content to be displayed. The adaptor module may be activated or loaded plug through execution of the contextual data initiation script.

The contextual data initiation script may be executed as part of running the webpage, or running a mobile app for viewing content, or as part of running the media player application. The control analytics data and web analytics data may be transmitted to the analysis server from the entity within which the contextual data initiation script is running.

Where the sensor data comprises a plurality of images showing the user’s reaction over time, the classification algorithm may operate to evaluate the presence parameter for each image in a plurality of images captured during the display of the content.

In addition to the presence data, the sensor data may be used to obtain emotional state information for the user if it is determined that a user is present, and especially if the user’s face is visible in a captured image. Thus, the method may further comprise: applying the sensor data to an emotional state classification algorithm to generate emotional state data for the user, wherein the emotional state classification algorithm is a machine learning algorithm operable to map the sensor data to a emotional state data, and wherein the emotional state data is indicative of a variation over time in a probability that the user has a given emotional state during display of the content; and synchronising the emotional state data with the presence data, whereby the effectiveness data set further comprises the emotional state data.

The user device may be arranged to respond locally to detected emotional state data and/or presence data. For example, the content may be obtained and displaying by an app running on the user device, where the app is configured to determine an action based on emotional state data and presence data generated at the user device.

The functionality described herein may be implemented as a software development kit (SDK) for use in creating apps or other programs that can utilise the presence parameter or effectiveness data described above. The software development kit may be configured to provide the classification algorithm.

The method discussed herein is scalable for a networked computing environment comprising a plurality of user devices, a plurality of content servers and a plurality of different pieces or types of content. The method may thus include receiving, by the analysis server, contextual attribute data and sensor data from a plurality of user devices. The analysis server may operate to aggregate a plurality of effectiveness data sets obtained from the contextual attribute data and sensor data received from the plurality of user devices, e.g. according to the process set out above. The plurality of effective data sets may be aggregated with respect to one or more common dimensions shared by the contextual attribute data and sensor data received from the plurality of user devices, e.g. for a given piece of media content, or for a group of related pieces of media content (e.g. relating to an ad campaign), or by web domain, by website identity, by time of day, by type of content or any other suitable parameter.

A result of carrying out the method discussed above may be a data store that has thereon a rich effective data set that links user presence with other observable factors. The effectiveness data sets may be stored in a data structure such as a database from which is can be queried to produce reports that enable relationships between the presence data and other data to be observed. The method may therefore further include: receiving, by a reporting device over the network, a query for information from the effectiveness data set; extracting, by the reporting device from the data store, response data in answer to the query; and transmitting, by the reporting device, the response data over the network. The query may be from a brand owner or a publisher.

The aggregated data may be used to update functionality on the user device. For example, where the content is obtained and displayed by an app running on the user device, the method may further comprise: determining a software update for the app using the aggregated effectiveness data sets; receiving the software update at the user device; and adjusting the app functionality by executing the software update.

In another aspect, the invention may provide a system for collecting data from a user device during output of information from user device, the system being configured to: collect, from the user device, contextual attribute data that is indicative of events occurring at the user device during the output of information; collect sensor data from one or more sensors on the user device during the output of information; apply the received sensor data to a classification algorithm to generate presence data, wherein the classification algorithm is a machine learning algorithm operable to map the sensor data to a presence parameter, and wherein the presence data is indicative of variation of the presence parameter over time during the output of information, and synchronise the presence data with the contextual attribute data to generate an effectiveness data set that links evolution over time of the presence parameter with corresponding contextual attribute data obtained during the output of information; and store the effectiveness data set in a data store. Features of the method discussed above may be equally applicable to the system.

As mentioned above, the effectiveness data produced by the system can be used to make predictions about how certain additional actions will affect the performance of a given piece of content or a given ad campaign. In another aspect of the invention, there is provided a method for optimising an ad campaign in which recommended actions that are supported by a predicted effect on performance against a campaign objective are used to adjust a programmatic advertising strategy.

According to this aspect, there may be provided a computer-implemented method for optimising a digital advertising campaign, the method comprising: accessing an effectiveness data set that expresses evolution over time of a presence parameter during playing of a piece of advertising content belonging to a digital advertising campaign to a plurality of users, wherein the presence parameter is obtained by applying sensor data collected from each user during playing of the piece of advertising content to a machine learning algorithm operable to map the sensor data to the presence parameter; generating a candidate adjustment to a target audience strategy associated with the digital advertising campaign; predicting an effect on the presence parameter applying the candidate adjustment; evaluating the predicted effect against a campaign objective for the digital advertising campaign; and updating the target audience strategy with the candidate adjustment if the predicted effect improves performance against the campaign objective by more than a threshold amount. The updating may be performed automatically, i.e. without human intervention. As such, the target audience strategy may be automatically optimised.

The effectiveness data set may be obtaining using the method discussed above, and therefore may have any of the features described herein. For example, the effectiveness data set may further include user profile information indicative of the users’ demographics and interests. In such an example, the candidate adjustment to the target audience strategy may alter demographic or interest information of the target audience.

In practice, the method may generate and evaluate a plurality of candidate adjustments. The method may automatically implement all adjustments that lead to an improvement greater than the threshold amount. Alternatively or additionally, the method may including a step of presenting (e.g. displaying) all or a subset of the adjustments that lead to an improvement greater than threshold amount. The method may include a step of selecting, e.g. manually or automatically, one or more of the adjustments to be used to update the target audience strategy.

The step of automatically updating the target audience strategy may comprise communicating a revised target audience strategy to a demand-side platform (DSP). A method according to this aspect may thus be performed in a network environment, e.g. comprises the DSP, the analysis server discussed above, and a campaign management server. The DSP may operate in a conventional manner based on instructions from the campaign management server. The analysis server may have access to the effectiveness data set, and may be the entity that runs the campaign objective optimisation based on information from the campaign management server. Alternatively, the campaign objective optimisation may run on the campaign management server, which may be configured to send queries to the analysis server, e.g. to obtain and/or evaluate the predicted effect of a candidate adjustment to a target audience strategy.

### BRIEF DESCRIPTION OF THE DRAWINGS

Embodiments of the invention are discussed in detail below with reference to the accompanying drawings, in which:

FIG. 1 is a schematic diagram of a data collection and analysis system that is an embodiment of the invention;

FIG. 2 is a flow diagram of a method of collecting and analysing data that is an embodiment of the invention;

FIG. 3 is a schematic diagram of a data collection and analysis system for generating an presence classifier suitable for use in the invention;

FIGS. 4 is a screenshot of a reporting dashboard that presents data resulting from execution of the method of FIG. 2; and

FIG. 5 is a flow diagram of an ad campaign optimisation method according to another aspect of the invention.

### DETAILED DESCRIPTION; FURTHER OPTIONS AND PREFERENCES

Embodiments of the invention relate to a system and method of collecting and utilising data from a user device while the user device is displaying web-based content. In the examples below the displayed content is media content, e.g. video or audio. However, it is to be understood that the invention is applicable to any type of content that can be presented by a user device.

In the present example, the system is configured to determine whether or not a user is present at a user device during playback of the media content. The determination may be made using data obtained from one or more sensors at the user device, for example from any one or more of a camera (e.g. webcam), microphone, motion sensor (e.g. gyroscope) or the like. The determination may be a binary decision, e.g. “user present” or “user absent”, or it may be a selection from multiple discrete states, e.g. “user present, face visible”, “user present, face not visible”, “user absent”, etc. Alternatively or additionally, the determination may involve obtaining a probability that a user is present or absent. A result of the determination may be referred to herein as “presence data”. The presence data may be characterised by a “presence parameter” that is indicative of whether or not a user is present. The data from the sensor or sensors on the user device may be referred to herein as “sensor data”. The sensor data can be image data (e.g. a single captured image or a video stream) and/or audio data. In one example, the system is configured to obtain presence data from collected sensor data. As explained below, the presence data may be obtained from the sensor data in an automated manner, e.g. by applying the sensor data to one or more classification algorithms that have been trained to recognise features associated with the presence of a user. The features may be visual features, e.g. parts of a human body such as face, torso, arms, hands, legs, etc. The features may be audible features, e.g. voice. When the user device is portable, the features may be patterns of motion, e.g. associated with walking, running, etc.

The presence data may be an output of the system. The presence data may be associated with, e.g. synchronised with, the media content that was being played back when the presence data was collected. The presence data alone may be a useful parameter against which to assess the utility or effectiveness of the media content.

In other examples, if the presence data indicates that a user is present, further data may be collected or further processing of the already collected sensor data may be performed to assess the impact or effect of the media content on the user. In one example, the system may inhibit collection of further data if the presence data indicates that a user is absent. This may prevent collection, processing and possibly transmission of unwanted data. In another example, if the collected sensor data includes image data, and the presence data indicates that a user is present with face visible, the system may analyse the image data to determine an emotional state of the user, or to determine whether or not the user is attentive.

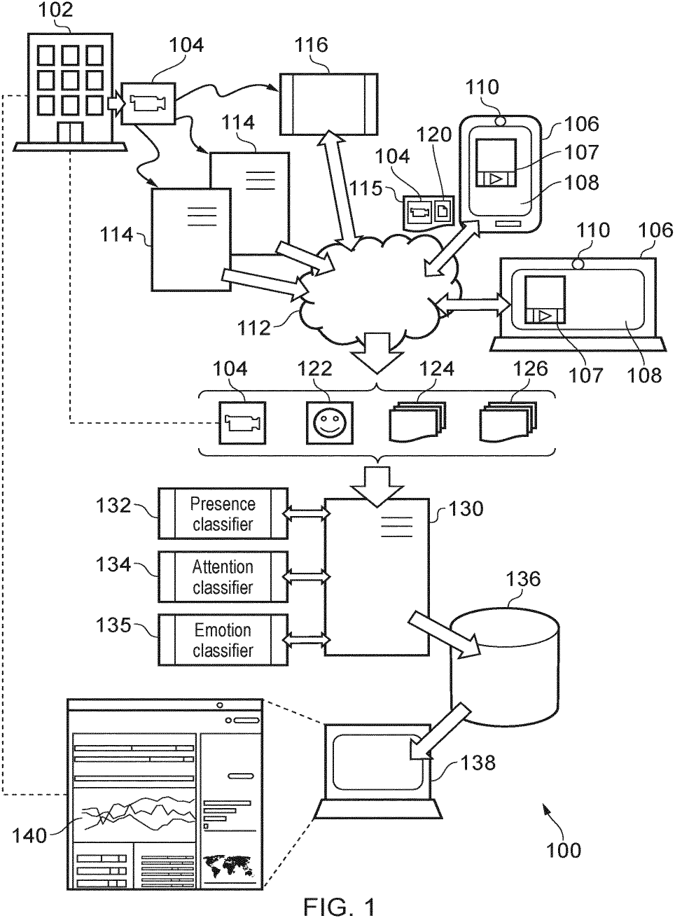

FIG. 1 is a schematic diagram of a data collection and analysis system 100 that is an embodiment of the invention. In the discussion below, the system is described in the context of evaluating media content 104 in the form of video ads that may be created, for example, by an brand owner 102. However, it can be understood that the system and method of the invention are applicable to any type of media content for which it is desirable to monitor, on a large scale, impact on users. For example, the media content may be training or safety videos, on-line learning materials, movies, music videos, or the like.

The system 100 is provided in a networked computing environment, where a number of processing entities are communicably connected over one or more networks. In this example, the system 100 comprises one or more user devices 106 that arranged to playback media content, e.g. via speakers or headphones and a software-based video player 107 on a display 108. The user devices 106 may also comprise or be connected to one or more sensors, such as webcams 110, microphones, etc. Example user devices 106 include smartphones, tablet computers, laptop computers, desktop computers, etc.

The user devices 106 are communicably connected over a network 112, such that they may receive served content 115 to be consumed, e.g. from a content server 114 (e.g. web host), which may operate under the control of a publisher, e.g. to deliver content on one or more channels or platforms. The publishers may sell “space” on their channels for brand owners to display video ads, either via an ad bidding process or by embedding the ads into content.

The served content 115 may thus include media content 104 directly provided by the content servers 114 or sent together with or separately from the served content by an ad server 116, e.g. as a result of an ad bidding process. The brand owner 102 may supply the media content 104 to the content servers 114 and/or the ad server 116 in any conventional manner. The network 112 can be of any type.

In this example, the served content includes code for triggering transmission of contextual attribute data 124 from the user device 106 over the network 112 to an analysis server 130. The code is preferably in the form of a tag 120 in the header of the main page loaded from the domain hosted by the content server 114. The tag 120 operates to load a bootstrapping script which performs a number of functions to enable delivery of information, including the contextual attribute data 124, from the user device 106. These functions are discussed below in more detail. However, in this example, the primary functions of the tag 120 are to trigger delivery of the contextual attribute data 124 and, where appropriate, a sensor data stream 122, such as a webcam recording comprising a video or image data from the camera 110 on the user device 106, to the analysis server 130.

The contextual attribute data 124 is preferably analytics data relating to events occurring at the user device after the main page is loaded. The analytics data may include any conventionally collected and communicated information for the main page, such as viewability of any element, clicks, scrolls, etc. This analytics data may provide a control baseline against which other metrics, such as the presence metric discussed below, are measured when the relevant media content 104 is in view or played back.

As mentioned above, the sensor data stream 122 sent to the analysis server 130 may include a video or set of images captured during playback the media content 104.

In addition to the sensor data 122 and contextual attribute data 124, the analysis server 130 is arranged to receive the media content 104 itself and a supplemental contextual attribute data stream 126 that comprises analytics data from the video player within which the media content is displayed. The media content 104 may be supplied to the analysis server 130 directly from the brand owner 102 or from a content server 114 or user device 106. The supplemental contextual attribute data stream 126 may be obtained by loading an adaptor for the video player 107 in which the media content 104 is displayed. Alternatively, the video player 107 may have a plug-in to provide the same functionality in the native environment of the video player 107.

The supplemental contextual attribute data stream 126 is obtained for the purpose of synchronising the sensor data 122 to playback positions within the media content and therefore provide brand measurement and creative level analytics. The supplemental contextual attribute data stream 126 may include viewability, playback event, click, and scroll data associated with the video player.

A separate mechanism for generating the supplemental contextual attribute data stream 126 is provided because the video player 107 may be deployed within an iframe, especially when the rendering of the media content 104 occurs via a third-party ad server 116. In such cases, the adapter must be deployed inside the iframe, where it can cooperate with the functionality of main tag 120 to record and transmit the data to the analysis server 130.

For example, the supplemental contextual attribute data stream 126 may include information relating to user instructions, such a pause/resume, stop, volume control, etc. Additionally or alternatively, the supplemental contextual attribute data stream 126 may include other information about delays or disruptions in the playback, e.g. due to buffering or the like.

In combination, the contextual attribute data stream 124 and the supplemental contextual attribute data stream 126 provide to the analysis server 130 a rich background context that can be related (and in fact synchronised) to a user’s response to the piece of media content obtainable from the sensor data stream 122.

The sensor data stream 122 may not be obtained from every user device on which the media content 104 is played. This may be because consent to share information has not been obtained, or because suitable sensors are not available. Where permission to share information is given, but no sensor data is obtained, the main tag 120 may nevertheless transmit the contextual attribute information 124, 126 to the analysis server 130.

The bootstrapping script may operate to determine whether or not a sensor data stream 122 is to be obtained from a given user device. This may involve a check on whether or not the user has been selected to participate, e.g. based on random sampling methodology, and/or based on publisher restrictions (e.g. because feedback from only some specific class of audience is required).

The bootstrapping script may operate initially to determine or obtain permissions for sharing the contextual attribute data 124 and the supplemental contextual attribute data 126 to the analysis server 130. For example, if a Consent Management Platform (CMP) exists for the domain in question, the script operates to check for consent from the CMP. It may also operate to check for global opt-out cookies associated with the analysis server or certain domains.

The bootstrapping script may then operate to check whether or not a sensor data stream 122 is to be obtained. If it is (e.g. because the user has been selected as part of the sample), the bootstrapping script may check the permission APIs of the camera 110 for recording and transmitting a camera feed. Because the sensor data stream 122 is transmitted with the contextual attribute data from the primary domain page, it is important that the tag for running the bootstrapping script is in the header of primary domain page, rather than any associated iframe.

In one example, the sensor data stream 122 is a full video recording from the camera 110 that is sent to the analysis server 130 over a suitable real-time communication protocol, such as WebRTC. To optimize page loading speed, the code for the WebRTC recording and on-device tracking is not loaded by the bootstrapping script before the relevant permissions are confirmed. In an alternative approach, the camera feed may be processed locally by the user device, such that only the detected presence metric (and, where appropriate, attention, emotion and other signals) are transmitted, so that no images or video leave the user device. In this approach, some functionality of the analysis server 130 discussed below is distributed to the user device 110.

In general, the function of the analysis server 130 is to convert the essentially free form viewing data obtained from the user devices 106 into a rich dataset that can be used to judge the effectiveness of the media content. As an initial step, the analysis server 130 operates to determine presence data for each user. Presence data can be obtained from the sensor data stream 122 by using a presence classifier 132, which in this example is an AI-based model that returns a probability that a user is located in the field of view of the camera. The presence classifier 132 may be configured to flag if a user’s face is visible in a given webcam frame, which may trigger further processing to determine if the user is paying attention to the content on screen.

The presence classifier 132 may output a time-varying signal that shows the evolution of user presence during playback of the media content 104. This can be synchronised with the media content 104 itself to enable the detected presence (and any associated attentive and distracted states) to be matched with playback of the media content. For example, where the media content is a video ad, a brand may be revealed at certain time points or periods within the video. The invention enables these time points or periods to be marked or labelled with presence and/or attentiveness information.

Similarly, the creative content of a video can be expressed as a stream of keywords associated with different time point or periods within the video. Synchronisation of the keyword stream with the presence metric can allow for correlations between keywords and presence (and corresponding attention or distraction) to be recognised.

The presence signal may also be synchronised with the contextual attribute signal in a similar way, thereby providing a rich dataset of contextual data synchronised with user presence evolution. These datasets, which can be obtained from each user that consumes media content are aggregated and stored in a data store 136, from where they can be queried and further analysed to generate reports, identify correlations and make recommendations, as discussed below.

The contextual attribute data 124 may also be used to give confidence or trust that the output from the presence classifier 132 applies to the relevant content, e.g. by permitting a cross check on what is visible on screen, or with interactions with the user device. For example, confidence in the presence data may be lost if the contextual attribute data 124 indicates that input commands are being received on the user device.

In circumstances where the presence metric indicates that a user is present, and in particular in scenarios where the user’s face is visible, the sensor data stream 122 may also be input to an attention classifier 134, which operates to generate a time-varying signal indicative of a user’s attentiveness when consuming the media content.

The sensor data stream 122 may also be input to an emotional state classifier 135, which operates to generate a time-varying signal indicative of a user’s emotion when consuming the media content. This emotional state signal may thus also be synchronised with the attentiveness signal, which enables the emotions associated with attention (or distraction) also to be assessed and reported.

In addition to generating the rich datasets discussed above, the analysis server 130 may be arranged to determine specific presence metrics for a given piece of media content. One example of a presence metric is presence volume, which may be defined as an average volume of presence detected during playback of the media content. For example, a presence volume score of 50% means that throughout the video viewers were present for half of the content on average. The more seconds of presence a video manages to attract, the higher this score will be. Another example of a presence metric is presence quality, which may be defined as the proportion of the media content for which respondents were continuously present, on average. For example, a score of 50% means that on average respondents were present without interruption for half of the video. This metric differs from presence volume because it is not the overall amount of presence that dictates the value of the score, but how presence was distributed along the viewing. Presence quality decreases when respondents move in and out of the field of view of the camera, which can show that they are distracted regularly.

The metrics above, or others, can be to determine the amount of contact between a user and a played back instance of media content on a user device. From the perspective of a brand owner or publisher, an advantage of this feature is that it becomes possible to report not only on number of impressions and number of views of a particular piece of media content, but also to be able to distinguish between views in which a user is present and views where the user was absent. Where a user is present, further analysis can be performed to assess their attentiveness and/or emotional state. The accompanying contextual attribute data then makes it possible to try to understand the levers that drive attention or distraction.

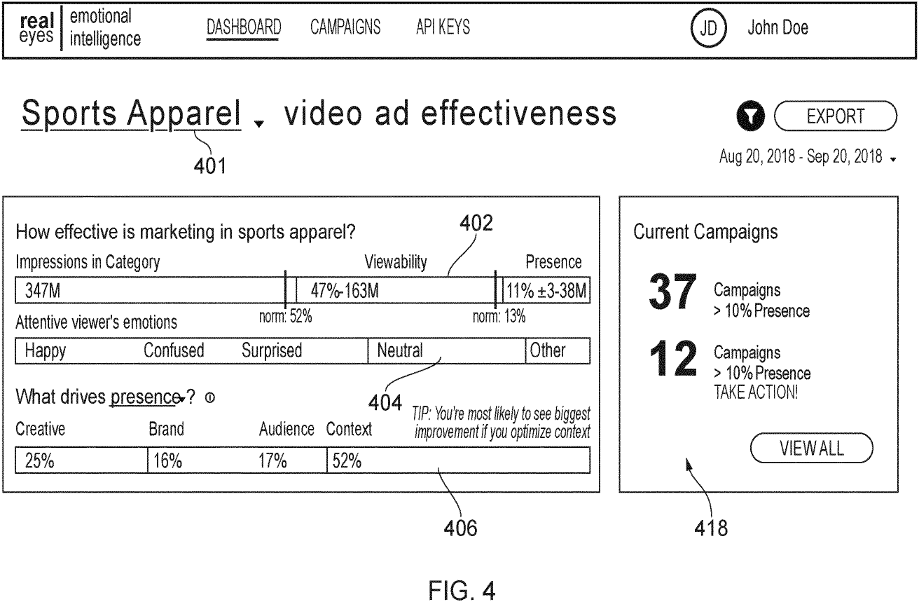

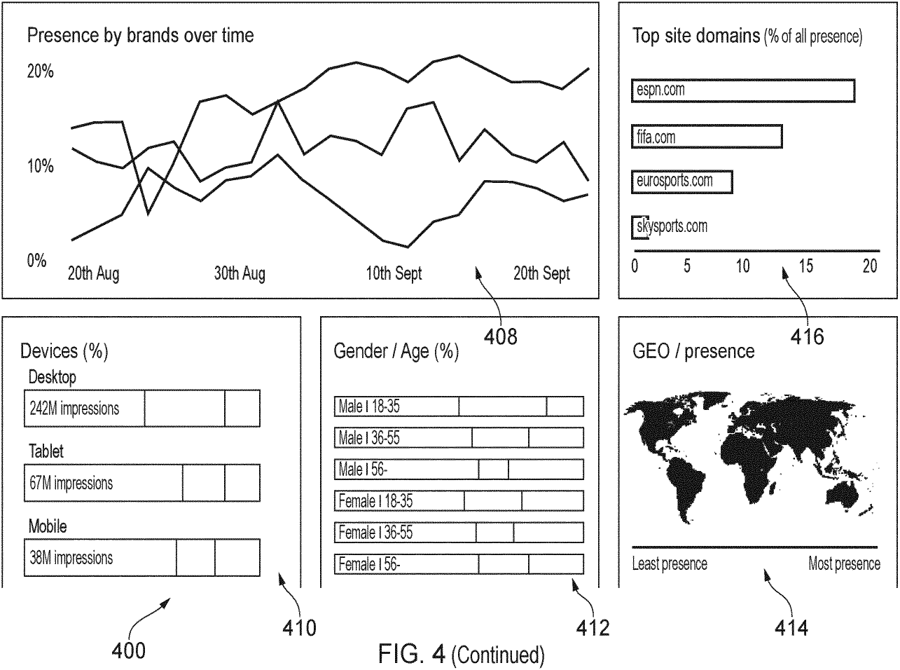

The system includes a report generator 138 that is arranged to query the data store 136 to generate one or more reports 140 that can be served to the brand owner 102, e.g. directly or over the network 112. The report generator 138 may be a conventional computing device or server arranged to query a database on the data store that contains the collected and synchronised data. An example of a report 140 is discussed in more detail below with reference to FIG. 4.

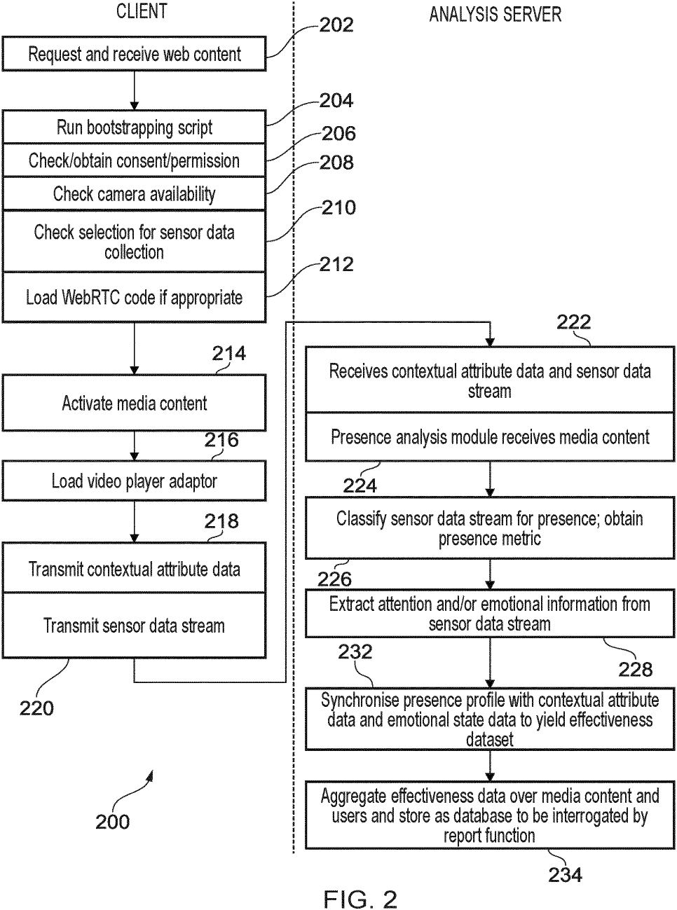

FIG. 2 is a flow chart showing step taken by a user device 106 and the analysis server 130 in a method 200 that is an embodiment of the invention.

The method begins with a step 202 of requesting and receiving, by the user device over a network, web content. Here web content is intended to mean a webpage that can be accessed and loaded from a domain, e.g. hosted by a content server 114 as discussed above.

The webpage includes in its header a tag that contains a bootstrapping script configured to run a number of preliminary checks and processes that enable collection of data from the user device. The method thus continues with a step 204 of running the bootstrapping script. One of the tasks performed by the script is to check for consent or obtain permission to share collected data with the analysis server. This may be done with reference to a Content Management Platform (CMP), if applicable to the domain from which the webpage is obtained. In this case, the bootstrapping script is located after code in the webpage header that initialises the CMP.

The method continues with a step 206 of checking or obtaining permission to share data. This can be done in any conventional manner, e.g. by checking the current status of the CMP, or providing an on-screen prompt. The permission is preferably requested at a domain level, so that repeated requests, e.g. upon accessing additional pages from the same domain, are avoided. The method includes a step 208 of checking for camera availability and obtaining consent for data collected from the camera to be transmitted to the analysis server.

If a camera is available, and consent for transmitting data from the camera is given, the method continues with a step 210 of checking whether or not the user has been selected or sampled for sensor data collection. In other embodiments this step 210 may occur before the step 208 of checking camera availability.

In some circumstances, all users with available cameras may be selected. However, in other examples, the users may be selected either to ensure that a suitable (e.g. random or pseudo-random) range of data is received by the analysis server 130, or to meet a requirement set by a brand owner or publisher (e.g. to collect data only from one population sector). In another example, the ability to select users may be used to control the rate of data received by the analysis server. This may be useful if there are problems with or restrictions on network bandwidth.

When a user gives consent for and is selected to transmit sensor data from the camera, the method continues with a step 212 of loading appropriate code to permit sharing of the camera data through the webpage. In one example, transmitting the behavioural data is done using the WebRTC protocol. It is preferable to defer loading the code for sensor data transmission until after it is determined that the sensor data is in fact to be transmitted. Doing so saves on network resources (i.e. unnecessary traffic) and facilitates a rapid initial page load.

Sometime after accessing the webpage and running the bootstrapping script , the method continues with a step 214 of activating, at the user device, media content. Activating media content may mean initiating playback of media that is embedded in the webpage, or encountering an ad space on the webpage that causes playback of a video ad received from an ad server, e.g. resulting from a conventional ad bidding process.

Playback of the media content may be done by executing a media player, e.g. a video player or the like. The media player may be embedded in the webpage, and configured to display the media content in an iframe within the webpage. Examples of suitable media players include Windows Media Player, QuickTime Player, Audacious, Amarok, Banshee, MPlayer, Rhythmbox, SMPlayer, Totem, VLC, and xine, or online video players, such as JW Player, Flowplayer, VideoJS and Brightcove, etc.

As discussed above, it is desirable to transmit to the analysis server contextual attribute data concerning the behavioural and control of the media player, i.e. analytics data for the media player. In order to achieve this, the method continues with a step 216 of loading an adaptor for the media player (or, if present, executing a plug-in of the media player) that is arranged to communicate the media player analytics data to the webpage, whereupon it can be transmitted to the analysis server.

The method continues with a step 218 of transmitting the contextual attribute data and a step 220 of transmitting, where applicable, the sensor data to the analysis server. Where the camera is available and consent is given, this means that the data transmitted to the analysis server comes from three sources:
(1) sensor data from camera - this is typically images or video from the camera itself. However, as discussed above, it is also possible that the user device itself will perform some preliminary analysis on the raw image data, e.g. to measure presence and/or to identify attention or emotions. In this example, the sensor data transmitted to the analysis server may already be the presence, attention and emotional state data; no image data need be transmitted;
(2) contextual data from webpage - this is typically analytics data associated with the domain from which the webpage is accessed; and
(3) contextual data from media player - this is typically analytics data associated with media player on which the media content is displayed.

The method now moves to the actions taken at the analysis server, which commences with a step 222 of receiving that data discussed above from the user device. The method also includes a step 224 of acquiring, by the analysis server, the media content that is the subject of the collected sensor data and contextual attribute data. The analysis server may obtain the media content directly from the brand owner or from a content server, e.g. based on an identifier transmitted by the user device. Alternatively, the analysis server may have a local store of media content.

The method continues with a step 226 of classifying the sensor data for presence. In this step, individual images from the data captured by the camera on the user device are fed to the presence classifier, which evaluates a probability that a user is present in the image. An output of the presence classifier may thus be a presence profile for the user for the media content, where the presence profile indicates evolution of presence with time over the duration of the media content. In another example, the classifier may be binary, i.e. may generate an output for each frame that is either “present” or “absent”. A presence profile can also be generated for such a two-state solution. In another example, the classifier may be trained to include labels for input data to qualify a presence signal. For example, the classifier may be able to distinguish between a state in which a user is present but where the user’s face cannot be read enough to ascertain if they are attentive or not, and a state in which the user is present with a face visible and suitable for further analysis. The classifier may thus output labels such as: “present, face visible”, “present, face not visible”, and “absent”.

The presence classifier or the analysis server may also be arranged to generate one or more presence metrics for that particular viewing instance of the media content. The presence metrics may be or include the presence volume and presence quality metrics discussed above.

The method continues with a step 228 of extracting attention or emotional state information from the sensor data stream. This may be done by an attention classifier and an emotion state classifier, and can be performed in parallel with step 226. An output of this step may be an attention profile or an emotional state profile that indicates evolution of attentiveness and/or one or more emotional states with time over the duration of the media content.

As discussed above, the sensor data stream may comprise image data captured by the camera, where the image data is a plurality of image frames showing facial images of the user. Where the image frames depict facial features, e.g. mouth, eyes, eyebrows etc. of a user. The facial features may provide descriptor data points indicative of position, shape, orientation, sharing, etc., of a selected plurality of the facial landmarks. Each facial feature descriptor data point may encode information that is indicative of a plurality of facial landmarks. Each facial feature descriptor data point may be associated with a respective frame, e.g. a respective image frame from the time series of image frames. Each facial feature descriptor data point may be a multi-dimensional data point, each component of the multi-dimensional data point being indicative of a respective facial landmark.

The emotional state information may be obtained directly from the raw sensor data input, of from descriptor data points extracted from the image data, or from a combination of the two. For example, the plurality of facial landmarks may be selected to include information capable of characterizing user emotion. In one example, the emotional state data may be determined by applying a classifier to one or more facial feature descriptor data points in one image or across a series of images. In some examples, deep learning techniques can be utilised to yield emotional state data from the raw data input.

The user emotional state may include one or more emotional states selected from anger, disgust, fear, happiness, sadness, and surprise.

The method continues with a step 232 of synchronising the presence profile 232 with the corresponding contextual attribute data and emotional state data, in order to generate a rich “effectiveness” dataset, in which the context of the periods of presence and absence in the presence profile are associated with various elements of the associated context.

The method continues with a step 234 of aggregating the effectiveness dataset obtaining for a plurality of viewed instances of the media content from a plurality of user devices (e.g. different users). The aggregated data is stored on a data store from where it can be queried to generate reports of the type discussed below with reference to FIG. 4.

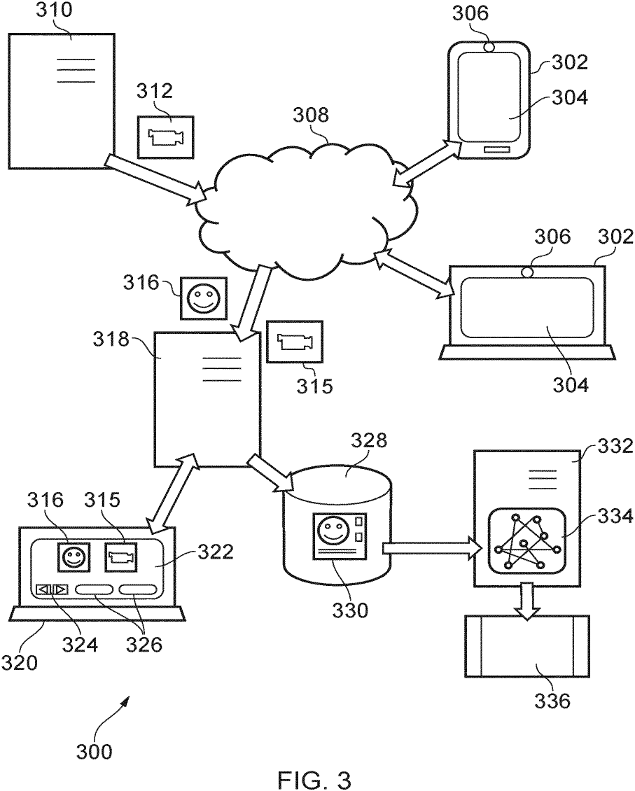

FIG. 3 is a schematic diagram of a data collection and analysis system 300 for generating a presence classifier suitable for use in the invention. It can be understood that the system in FIG. 3 illustrates components for performing collection and annotation of data, as well as for subsequent use of that data in generating and utilising the presence classifier.

The system 300 is provided in a networked computing environment, where a number of processing entities are communicably connected over one or more networks. In this example, the system 300 comprises one or more user devices 302 that arranged to playback media content, e.g. via speakers or headphones and a display 304. The user devices 302 may also comprise or be connected to sensor components, such as webcams 306, microphones, etc. Example user devices 302 include smartphones, tablet computers, laptop computers, desktop computers, etc.

The user devices 302 are communicably connected over a network 308, such that they may receive media content 312 to be consumed, e.g. from a content provider server 310.

The user devices 302 may further be arranged to send collected sensor information over the network for analysis or further processing at a remote device, such as analysis server 318.

In this example, the information sent to the analysis server 318 may include a video or set of images captured during playback of media content. The information may also include the associated media content 315 or a link or other identifier that enables the analysis server 318 to access the media content 312 that was consumed by the user. The associated media content 315 may include information concerned the manner in which the media content was played back at the user device 302. For example, the associated media content 315 may include information relating to user instructions, such a pause/resume, stop, volume control, etc. Additionally or alternatively, the associated media content 315 may include other information about delays or disruptions in the playback, e.g. due to buffering or the like. This information may correspond to (and be obtained in a similar manner to) the analytics data from the media player discussed above. The analysis server 318 may thus receive a data stream comprises information relating to playback of the piece of media content at a user device.

In the present example, the purpose of collecting sensor information it to be annotated with presence labels.

The system 300 provides an annotation tool 320 that facilitates execution of the annotation process. The annotation tool 320 may comprise a computer terminal in communication (e.g. networked communication) with the analysis server 318. The annotation tool 320 includes a display 322 for showing a graphical user interface to a human annotator (not shown). The graphical user interface may take many forms. However, in may usefully comprise a number of functional elements. Firstly, the graphical user interface may present collected sensor data 316 alongside associated media content 315 in a synchronised manner.

The graphical user interface may include a controller 324 for controlling playback of the synchronised response data 316 and associated media content. For example, the controller 324 may allow the annotator to play, pause, stop, rewind, fast forward, backstep, forward step, scroll back, scroll forward or the like through the displayed material.

The graphical user interface may include one or more score applicators 326 for applying a presence score to a portion or portions of the response data 316. In one example, a score applicator 326 may be used to apply a presence score to a period of a video or set of image frames corresponding to a given time period of the collected sensor data. The presence score may have any suitable format. In one example it is binary, i.e. a simple yes/no indication of presence. In other examples, the presence score may be selected from a set number of predetermined levels, or may be chosen from a numerical range (e.g. a linear scale) between end limits that represent absence and presence with clearly visible face respectively.

Simplifying the annotation tool may be desirable in terms of expanding the potential annotator pool. The simpler the annotation process, the less training is required for annotators to participate. In one example, annotated data may be harvested using a crowd-sourcing approach.

The annotation tool 320 may thus represent a device for receiving a time series of data indicative of a user’s presence while consuming a piece of media contact. The attention data may be synchronised (e.g. by virtue of the manner in which the score is applied) with the response data 316. The analysis server 318 may be arranged to collate or otherwise combine the received data to generate presence-labelled sensor data 330 that can be stored in a suitable storage device 328.

The presence data from multiple annotators may be aggregated or otherwise combined to yield a presence score for a given response. For example, presence data from multiple annotators may be averaged over portions of the media content.

The analysis server 318 may be arranged to receive the presence data from multiple annotators. The analysis server 318 may generate combined presence data from the different sets of presence data. The combined presence data may comprise a presence parameter that is indicative of level of positive correlation between the presence data from the plurality of annotators. In other words, the analysis server 318 may output a score that quantifies the level of agreement between the binary selections made by the plurality of annotators across the response data. The presence parameter may be a time-varying parameter, i.e. the score indicating agreement may vary across the duration of the response data to indicate increasing or decreasing correlation.

In a development of this concept, the analysis server 318 may arranged to determine and store a confidence value associated with each annotator. The confidence value may be calculated based on how well the annotators individual scores correlate with the combined presence data. For example, an annotator who regularly scores in the opposite direction to the annotator group when taken as a whole may be assigned a lower confidence value than an annotator who is more often in line. The confidence values may be updated dynamically, e.g. as more data is received from each individual annotator. The confidence values may be used to weight the presence data from each annotator in the process of generating the combined presence data. The analysis server 318 may thus exhibit the ability to ‘tune’ itself to more accurate scoring.

The presence-labelled sensor data 330 may include the presence parameter. In other words, the presence parameter may be associated with, e.g. synchronised or otherwise mapped to or linked with, events in the data stream or media content.

The presence-labelled sensor data 330 may include any one or more of: the original collected data 316 from the user device 302 (e.g. the raw video or image data, which is also referred to herein as the response data); the time series of presence data; time series data corresponding to one or more physiological parameters from the physiological data 314; and emotional state data extracted from the collected data 316.

The collected data may be image data captured at each of the user device 302. The image data may include a plurality of image frames showing facial images of a user. Moreover, the image data may include a time series of image frames showing facial images of a user.

Where the image frames depict facial features, e.g. mouth, eyes, eyebrows etc. of a user, and each facial feature comprises a plurality of facial landmarks, the behavioural data may include information indicative of position, shape, orientation, shading etc. of the facial landmarks for each image frame.

The image data may be processed on respective user devices 302, or may be streamed to the analysis server 318 over the network 308 for processing.

The facial features may provide descriptor data points indicative of position, shape, orientation, sharing, etc., of a selected plurality of the facial landmarks. Each facial feature descriptor data point may encode information that is indicative of a plurality of facial landmarks. Each facial feature descriptor data point may be associated with a respective frame, e.g. a respective image frame from the time series of image frames. Each facial feature descriptor data point may be a multi-dimensional data point, each component of the multi-dimensional data point being indicative of a respective facial landmark.

The emotional state information may be obtained directly from the raw data input, from the extracted descriptor data points or from a combination of the two. For example, the plurality of facial landmarks may be selected to include information capable of characterizing user emotion. In one example, the emotional state data may be determined by applying a classifier to one or more facial feature descriptor data points in one image or across a series of images. In some examples, deep learning techniques can be utilised to yield emotional state data from the raw data input.

The user emotional state may include one or more emotional states selected from anger, disgust, fear, happiness, sadness, and surprise.

The creation of the presence-labelled sensor data represents a first function of the system 300. A second function, described below, is in the subsequent use of that data to generate and utilise an presence model for the presence classifier 132 discussed above.

The system 300 may comprise a modelling server 332 in communication with the storage device 328 and arranged to access the presence-labelled sensor data 330. The modelling server 332 may connect directly to the storage device 328 as shown in FIG. 3 or via a network such as network 308.

The modelling server 332 is arranged to apply machine learning techniques 334 to a training set of presence-labelled sensor data 330 in order to establish a model 336 for scoring presence from unlabelled response data, e.g. sensor data 316 as originally received by the analysis server 318. The model may be established as an artificial neural network trained to recognise patterns in collected response data that are indicative of high levels of presence. The model can therefore be used to automatically score collected response data, without human input, for presence. An advantage of this technique is that the model is fundamentally based on direct measurements of presence that are sensitive to contextual factors that may be missed by measurements or engagement or presence that rely on certain predetermined proxies.

In one example, the presence-labelled sensor data 330 used to generate the presence model 336 may also include information about the media content. This information may relate to how the media content is manipulated by the user, e.g. paused or otherwise controlled. Additionally or alternatively, the information may include data about the subject matter of the media content on display, e.g. to give context to the collected response data.

Herein the piece of media content may be any type of user-consumable content for which information regarding user feedback is desirable. The invention may be particular useful where the media content is a commercial (e.g. video commercial or advert), where user presence is closely linked to performance, e.g. sales uplift or the like. However, the invention is applicable to any kind of content, e.g. any of a video commercial, an audio commercial, a movie trailer, a movie, a web advertisement, an animated game, an image, etc.

FIG. 4 is a screenshot of a reporting dashboard 400 that comprises a presentation of the rich effectiveness data stored on the data store 136 of FIG. 1 for a range of different media content, e.g. a group of ads in a common field. The common field may be indicated by main heading 401, which is shown as “sports apparel” in FIG. 4, but may be changed, e.g. by the user selecting from a drop down list.

The dashboard 400 includes an impression categorisation bar 402, in which the relative proportion of total served impressions which were (i) viewable (i.e. visible on screen), and (ii) viewable with a user present, i.e. having an presence score above a predetermined threshold. Norms may be marked on the bar to shown how the viewability and presence proportions compare with expected performance.

The dashboard 400 may further include a relative emotional state bar 404, which shows the relative strength of the emotional states detected from present viewers from whom that information is available.

The dashboard 400 further includes a driver indicator bar 406, which in this example shows the relative amount by which different contextual attribute categories are correlated to detected presence. Each of the contextual attribute categories (e.g. creative, brand, audience and context) may be selectable to provide a more detailed breakdown of the factors that contribute to that category. For example, the “creative” category may relate to information presented in the media content. The contextual attribute data may include a content stream that describes the main items that are visible at any point of time in the media content. In FIG. 4, the driver indicator bar 406 shows the correlation of categories to presence. However, it may be possible to select other feature for which the relative strength of correlation with the categories is of interest, such as particular emotional states.

The dashboard 400 further includes a brand presence chart 408, which shows the evolution over time of the level of exposure (i.e. display to present viewers) achieved by various brands in the common field indicated in main heading 401.

The dashboard 400 further includes a series of charts that break down the impression categorisation by contextual attribute data. For example, chart 410 breaks down the impression categorisation by viewing device type, while chart 412 breaks down the impression categorisation using gender and age information.

The dashboard 400 further includes a map 414 in which relative presence is illustrated using location information from the contextual attribute data.

The dashboard 400 further includes a domain comparison chart 416 which compares the amount of presence associated with the web domain from which the impressions are obtained.

Finally, the dashboard 400 may further comprise a summary panel 418, which classifies campaigns covered by the common field according to a predetermined presence threshold. The threshold is 10% in this example, which means that 10% of impressions are detected as having a present viewer.

The presence data collected by the system disclosed above may be used to control a programmatic advertising campaign. The control may be done manually, e.g. by adapting instructions to a DSP based on the recommendations provided on the report. However, it may be particular useful to implement automated adjustment of the programmatic advertising instructions to effectively establish an automated feedback loop that optimises the programmatic advertising strategy to meet the campaign objective.

The term “programmatic advertising” is used herein to refer to an automated process for buying digital advertising space, e.g. on webpages, online media players, content sharing platforms, etc. Typically the process involves real-time bidding for each advertising slot (i.e. each available ad impression). In programmatic advertising, a DSP operates to automatically select a bid in response to an available ad impression. The bid is selected based in part on a determined level of correspondence between a campaign strategy supplied to the DSP by an advertiser and contextual information about the ad impression itself. The campaign strategy identifies a target audience, and the bid selection process operates to maximise the likelihood of the ad being delivered to some within that target audience.

In this context, the present invention can be used as a means of adjusting, in real time and preferably in an automated manner, the campaign strategy that is provided to the DSP. In other words, the recommendations that are output from the analysis server may be used to adjust the definition of the target audience for a given ad campaign.

In one example, the system discussed above with respect to FIG. 1 may be used to provide information about presence in relation to a software platform or application on which a variety of content may be consumed. The platform may be a content sharing platform or app, such as YouTube, Facebook, Vimeo, TikTok, etc. A publisher may thus obtain information relating to presence on the platform, which may inform or facilitate optimisation of a strategy for sharing or otherwise distributing content thereon. The presence information may be across an entire platform, or may relate to certain dedicated channels provided by the platform. In one example, the information about presence data may include variation of presence data by time of day and/or geographical location.

The information about presence data across a platform or app may be used to influence the provision of advertising space thereon. For example, measured presence may be used as a metric to trigger generation of ad inventory, i.e. space to present advertising. For example, if measured presence on a particular channel or app exceeds a predetermined threshold, additional ad inventory may be provided. Alternatively or additionally, presence may be used as a metric to adjust or other control a cost of ad inventory. In one example, a publisher (provider of ad inventory) may increase the cost of ad inventory that is associated with a level of presence above a certain threshold. In another example, an advertiser (seeking to purchase ad inventory to obtain ad impressions) may adjust their bidding strategy, i.e. the amount they are willing to bid for ad space, based on a presence metric associated with the ad inventory.

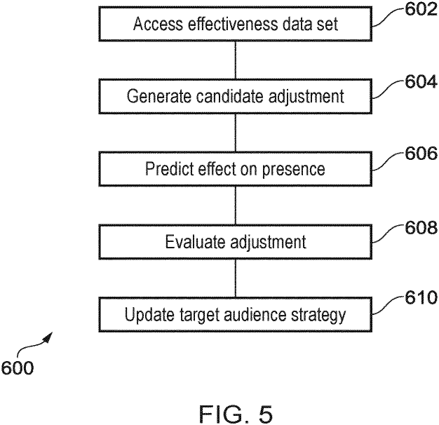

FIG. 5 is a flow diagram of a method 600 for optimising a digital advertising campaign. The method is applicable to programmatic advertising techniques, in which the digital advertising campaign has a defined objective and a target audience strategy that aims to achieve that objective. The target audience strategy may form the input to a demand-side platform (DSP) tasked with delivered advertising content to users in a manner that fulfils the defined objective.

The method 600 begins with a step 602 of accessing an effectiveness data set that expresses evolution over time of a presence parameter during playing of a piece of advertising content belonging to a digital advertising campaign to a plurality of users. The effectiveness data set may be of the type discussed above, wherein the presence parameter is obtained by applying behavioural data collected from each user during playing of the piece of advertising content to a machine learning algorithm trained to map behavioural data to the presence parameter.

The method continues with a step 604 of generating a candidate adjustment to the target audience strategy associated with the digital advertising campaign. The candidate adjustment may vary any applicable parameter of the target audience strategy. For example, it may alter demographic or interest information of the target audience. A plurality of candidate adjustments may be generate. The candidate adjustment may be generated based on information from the effectiveness data set for the digital ad campaign. For example, the candidate adjustment may seek to increase the influence of portions of the target audience for which the presence parameter is relatively high, or reduce the influence of portions of the target audience for which the presence parameter is relatively low.

The method continues with a step 606 of predicting an effect on the presence parameter of applying the candidate adjustment.

The method continues with a step 608 of evaluating the predicted effect against a campaign objective for the digital advertising campaign. The campaign objective may be quantified by one or more parameters. The evaluating step thus compares the predicted values of those parameters against current values for the digital advertising campaign. In one example, the campaign objective may be concerned with maximising presence, and hence an improvement to the target audience strategy would manifest as an increase in the presence parameter.

The method continues with a step 610 of updating the target audience strategy with the candidate adjustment if the predicted effect improves performance against the campaign objective by more than a threshold amount. In the example above, this may be an improvement in the presence parameter (e.g. share of present viewers realised by the ad campaign) above a threshold amount. The updating may be performed automatically, i.e. without human intervention. As such, the target audience strategy may be automatically optimised.

As discussed above, the present invention may find use in measuring the effectiveness of advertising. However, it may also find use in other spheres.

For example, the invention may find use in the evaluation of online educational materials, such as video lectures, webinars, etc. It may also be used to measure presence to locally displayed written text, survey questions, etc. In this context it can be used to assess the effectiveness of the content itself or of the individual trainee, for example, if they have been present during display of the training materials enough to be permitted to take an exam.

In another example, the invention may be used in gaming application, either running locally on the user device, or online, with single or multiple participants. Any aspect of gameplay may provide displayed content for which presence is measurable. The invention may be used as a tool to direct and measure the effectiveness of changes to gameplay.

1. A computer-implemented method of collecting data from a user device, the method comprising:
outputting information from the user device;
collecting contextual attribute data that is indicative of events occurring at the user device during the output of information;
collecting, by a sensor at the user device, sensor data during the output of information;
generating presence data by applying the sensor data to a classification algorithm , wherein the classification algorithm is a machine learning algorithm that maps the sensor data to a presence parameter, and wherein the presence data is indicative of variation of the presence parameter over time during display of the content;
synchronising the presence data with the contextual attribute data to generate an effectiveness data set that links evolution over time of the presence parameter with corresponding contextual attribute data obtained during the output of information; and
storing the effectiveness data set in a data store.

2. The computer-implemented method of claim 1, wherein the step of outputting information comprises displaying content on the user device.

3. The computer-implemented method of claim 2, wherein the displayed content comprises media content, and wherein the method further comprises:
executing an app on the user device; and
playing, by the app running on the user device, the media content,
wherein the contextual attribute data is further indicative of an events occurring at the app during playing of the media content.

4. The computer-implemented method of claim 3, wherein the contextual attribute data comprises control analytics data for the app.

5. The computer-implemented method of claim 3, wherein the step of executing the app generates the presence data and synchronises the presence data with the contextual attribute data.

6. The computer-implemented method of claim 3, wherein the step of executing the app comprises communicating with an analysis module running in the background on the user device, wherein the analysis module is generates the presence data and synchronises the presence data with the contextual attribute data.

7. The computer-implemented method of claim 3, wherein the app comprises an adaptor module configured to communicate with an analysis server over a network.

8. The computer-implemented method of claim 2, wherein displaying the content comprises:
accessing, by the user device over a network, a webpage on a web domain hosted by a content server;
receiving, by the user device over the network, the content to be displayed by the webpage, wherein the contextual attribute data is further indicative of events occurring at the webpage during display of the content.

9. The computer-implemented method of claim 8, wherein accessing the webpage includes obtaining a contextual data initiation script for execution on the user device, and wherein the method further includes:
executing the contextual data initiation script at the user device; and
injecting, by an intermediary on the network between the content server and user device, the contextual data initiation script into source code of the webpage.

10. (canceled)

11. The computer-implemented method of claim 9, wherein obtaining the contextual data initiation script comprises:
transmitting, by the user device, an ad request; and
receiving, from an ad server, a video ad response in response to the ad request,
wherein the contextual data initiation script is included in the video ad response.

12. The computer-implemented method of claim 9, wherein upon executing the contextual data initiation script, the method further includes:
determining consent to transmit the contextual attribute data and sensor data to a remote analysis server;
determining availability of the sensor for collecting the sensor data; and
ascertaining whether or not the user is selected for sensor data collection, wherein the method further comprises terminating a sensor data collection procedure upon determining, by the user device using the contextual data initiation script, that:
(i) consent to transmit sensor data is withheld, or
(ii) a device for collecting the sensor data is not available, or
(iii) the user is not selected for sensor data collection.

13. The computer-implemented method of claim 11, wherein the method further comprises loading a real-time communication protocol for transmitting the sensor data from the user device to the analysis server upon determining, by the user device using the contextual data initiation script, that (i) consent to transmit sensor data is given, and (ii) a device for collecting the sensor data is available, and (iii) the user is selected for sensor data collection.

14-16. (canceled)

17. The computer-implemented method of claim 1, wherein collecting, by the sensor at the user device, sensor data of the user comprises capturing images using a camera., and wherein the classification algorithm operates to evaluate the presence parameter for each image in a plurality of images of the user captured during the output of information.

18. (canceled)

19. The computer-implemented method of claim 1 further comprising:
applying the sensor data to an emotional state classification algorithm to generate emotional state data for the user, wherein the emotional state classification algorithm is a machine learning algorithm operable to map the sensor data to emotional state data, and wherein the emotional state data is indicative of a variation over time in a probability that the user has a given emotional state during the output of information; and
synchronising the emotional state data with the presence data, whereby the effectiveness data set further comprises the emotional state data.

20. The computer-implemented method of claim 1, further comprising:
receiving, by a remote analysis server over a network, contextual attribute data and sensor data from a plurality of user devices; and
aggregating, by the analysis server, a plurality of effectiveness data sets obtained from the contextual attribute data and sensor data received from the plurality of user devices.

21-22. (canceled)

23. The computer-implemented method of claim 20, wherein the output information is content is-obtained and displayed by an app running on the user device, and wherein the method further comprises:
determining a software update for the app using the aggregated effectiveness data sets;
receiving the software update at the user device; and
adjusting the app functionality by executing the software update.

24. A system for collecting data from a user device during output of information from user device, the system being configured to:
collect, from the user device, contextual attribute data that is indicative of events occurring at the user device during the output of information;
collect sensor data from one or more sensors on the user device during the output of information;
apply the received sensor data to a classification algorithm to generate presence data, wherein the classification algorithm is a machine learning algorithm operable to map the sensor data to a presence parameter, and wherein the presence data is indicative of variation of the presence parameter over time during the output of information, and
synchronise the presence data with the contextual attribute data to generate an effectiveness data set that links evolution over time of the presence parameter with corresponding contextual attribute data obtained during the output of information; and
store the effectiveness data set in a data store.

25. A computer-implemented method for optimising a digital advertising campaign, the method comprising:
accessing an effectiveness data set that expresses evolution over time of a presence parameter during playing of a piece of advertising content belonging to a digital advertising campaign to a plurality of users, wherein the presence parameter is obtained by applying sensor data collected from each user during playing of the piece of advertising content to a machine learning algorithm operable to map the sensor data to the presence parameter;
generating a candidate adjustment to a target audience strategy associated with the digital advertising campaign;
predicting an effect on the presence parameter applying the candidate adjustment;
evaluating the predicted effect against a campaign objective for the digital advertising campaign; and
updating the target audience strategy with the candidate adjustment if the predicted effect improves performance against the campaign objective by more than a threshold amount.

26. The computer-implemented method of claim 25, wherein the effectiveness data set further includes user profile information indicative of the users’ demographics and interests, and wherein the candidate adjustment to the target audience strategy changes demographic or interest information of the target audience.

27. (canceled)

28. The computer-implemented method of claim 25, wherein updating the target audience strategy with the candidate adjustment occurs if the predicted effect improves the presence parameter by more than a threshold amount.

29. (canceled)
